(19) United States
(12) Patent Application Publication
(10) Pub. No.: US 2008/0144325 A1
(43) Pub. Date: Jun. 19, 2008

(54) REMOVABLE LIGHT SURROUND

(75) Inventor: Victoria Jean Van Dyn Hoven, Stevens Point, WI (US)

Correspondence Address: RATHE PATENT & IP LAW, 10611 W. HAWTHORNE FARMS LANE, MEQUON, WI, 53097, US

(73) Assignee: Vickie Jean's Creations, Inc., Plover, WI (US)

(21) Appl. No.: 12/037,933

(22) Filed: Feb. 26, 2008

Related U.S. Application Data
(63) Continuation of application No. 29/280,318, filed on May 23, 2007, now Pat. No. D565209.
(60) Provisional application No. 60/891,940, filed on Feb. 27, 2007.

(51) Int. Cl. F21V 11/00

(52) U.S. Cl. 362/353

(57) ABSTRACT

A decorative lighting apparatus and method include a plurality of mini-light surrounds, each surround formed from silicone. Each surround has a conical cavity configured to stretch when receiving a mini-light to removably retain the surround on the mini-light. Each surround has an outer three dimensional shape different than the mini-light.

### CROSS-REFERENCE TO RELATED PATENT APPLICATIONS

The present application claims priority under 35 USC 119(e) from co-pending U.S. Provisional Application 60/891,940 filed on Feb. 27, 2007 by Victoria Jean Van Dyn Hoven and entitled REMOVABLE LIGHT SURROUND, the full disclosure of which is hereby incorporated by reference. The present application claims party under 35 USC 120 from co-pending U.S. application Ser. No. 29/280,318 filed on May 23, 2007 by Victoria Jean Van Dyn Hoven and entitled STAR LIGHT STRING, the full disclosure of which is hereby incorporated by reference.

The present application is related to co-pending U.S. patent application Ser. No. 11/481,471 filed by Victoria Jean Van Dyn Hoven on Jul. 6, 2006 and entitled LIGHT SURROUND, the full disclosure of which is hereby incorporated by reference. The present application is related to co-pending U.S. patent application Ser. No. 11/481,631 filed by Victoria Jean Van Dyn Hoven on Jul. 6, 2006 and entitled LIGHT SURROUND, the full disclosure of which is hereby incorporated by reference. The present application

### BACKGROUND

Mini lights are typically provided as part of a string and have generally cylindrical bulbs with conical tips. The mini lights may be all of one color or may have a predefined pattern of different colors.

### BRIEF DESCRIPTION OF THE DRAWINGS

FIG. 1 is a fragmentary perspective view of a decorative lighting system according to an example embodiment.

FIG. 2A is an enlarged fragmentary perspective view of the decorative lighting system of FIG. 1.

FIG. 2B is a front elevational view of the decorative lighting system of FIG. 2A according to an example embodiment.

FIG. 2C is a rear elevational view of the decorative lighting system of FIG. 2A according to an example embodiment.

FIG. 2D is a left side elevational view of the decorative lighting system of FIG. 2A according to an example embodiment.

FIG. 2E is a right side elevational view of the decorative lighting system of FIG. 2A according to an example embodiment.

FIG. 2F is a top plan view of the decorative lighting system of FIG. 2A according to an example embodiment.

FIG. 2G as a bottom plan view of the decorative lighting system of FIG. 2A according to an example embodiment.

FIG. 3 is an exploded front elevational view of the decorative lighting system of FIG. 2A according to an example embodiment.

FIG. 4 is a front elevational view of the decorative lighting system of FIG. 2A and an illuminated state according to an example embodiment.

FIG. 5 is a front elevational view of a light surround of the decorative lighting system of FIG. 2A according to an example embodiment.

FIG. 6 as a bottom perspective view of the light surround of FIG. 5 according to an example embodiment.

FIG. 7 is another embodiment of the decorative lighting system of FIG. 1 according to an example embodiment.

### DETAILED DESCRIPTION OF THE EXAMPLE EMBODIMENTS

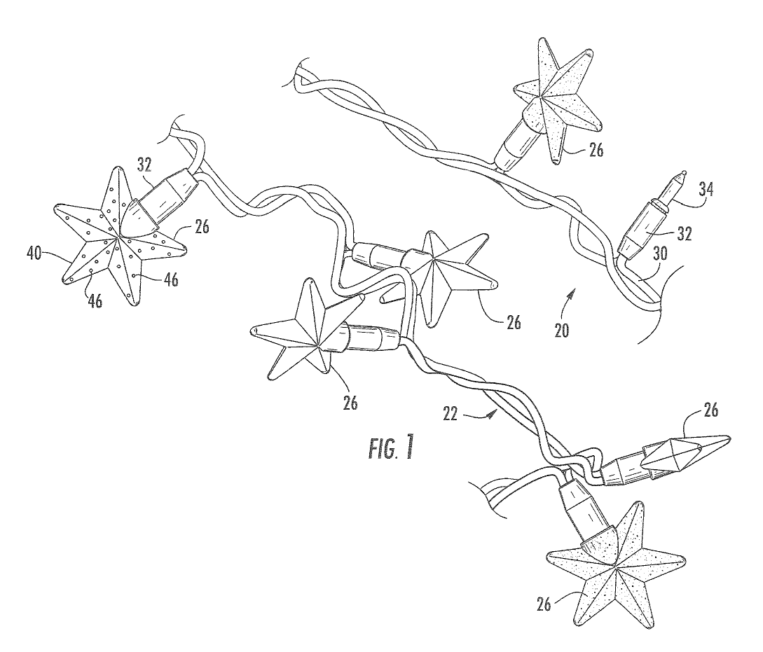

FIG. 1 illustrates decorative lighting system 20 according to one example embodiment. Lighting system 20 provides decorative lighting, wherein light is transmitted through a decoratively shaped translucent body or surround. As will be described in more detail hereafter, such surrounds are configured to be removably positioned about the light, permitting the surrounds to be reused when the light or light string are no longer used such as when one or more lights burn out. At the same time, such surrounds permit an off-the-shelf light string to be customized. In particular, the surrounds permit a person to selectively change not only the color of the illumination provided by each mini light but also the shape of the illumination provided by each many light.

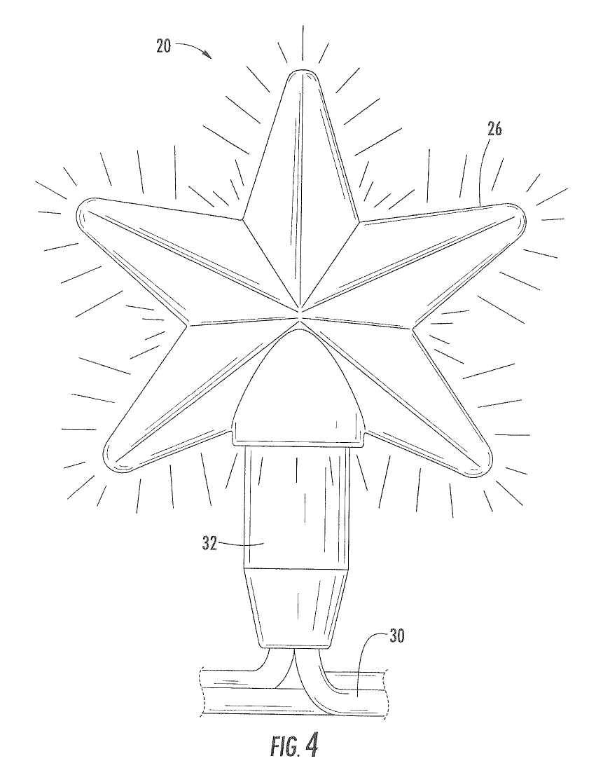

Decorative lighting system 20 includes light string 22 and a light surrounds 26. Light string 22 comprises a light string configured to be electrically connected to an electrical outlet of a business or residence. Light string 22 includes a plug (not shown), electrical wiring 30, light bulb sockets 32 and light bulbs or lights 34 (shown in FIG. 3). The plug electrically connects the wiring to an outlet, such as a standard 120 V outlet, or another electrically powered string of lights. Wiring 30 transmits electrical current to light bulb sockets 32. Light bulb sockets 32 removably receive lights 34. In other embodiments, light bulb sockets 32 main non-removably receive lights 34.

Lights 34 comprise elements which convert electrical energy into visible light. In the particular embodiment illustrated, lights 34 comprise incandescent lights having filaments or other elements that heat up to emit light. In the particular example illustrated, lights 34 comprise what are commonly referred to in the lighting industry as “mini-lights,” a small 2.5 volt light. Such lights are generally connected in series along wiring 30. In the particular embodiment illustrated, light string 22 may have any of a variety of number of lights 34 along wiring 30. As will be described in more detail hereafter, surrounds 26 are especially beneficial for use with a light string 22 having mini-lights. However, in other embodiments, surrounds 26 may alternatively be configured for use with a light string 22 supporting other forms of lights or in other arrangements where lights 34 are not supported along a flexible electrical wiring or string but are mounted to a stationary, inflexible support.

Surrounds 26 comprise translucent bodies configured to be removably positioned upon and at least partially about lights 34. For purposes of this disclosure, the term “removably” in the context of surrounds 26 shall mean that they light 34 may be separated or withdrawn from surround 26 while the light 34 remains completely attached to socket 32 and that light 34 may be removed from surround 26 without damage to or alteration of light 34 or its electrical connection to socket 32. In the particular example illustrated, surrounds 26 are configured to permit withdrawal of lights 34 from surrounds 26 without any modification or adjustment of light 34 or socket 32 and without the need for any tools. Likewise, surround 26 are also configured for positioning upon and about lights 34 without any modification or adjustment of light 34 or socket 32 and without the need for tools. As a result, surrounds 26 may be easily added to or removed from an existing light string 22.

As shown by FIG. 1, decorative lighting system 20 includes multiple different colors of surrounds 26. In one embodiment, surrounds 26 have a color or tint different than that of the color of the light emitted by lights 34. For example, in one embodiment, lights 34 may emit a white light, wherein some of surrounds 26 are green in color and some of surrounds 26 are tan or yellow in color. In yet another embodiment, lights 34 may emit one or more other colors of light, wherein each surround 26 as a color different than the color of light emitted by the associated light 34. In still other embodiments, surrounds 26 may have subjected the same color as that of the light emitted by lights 34.

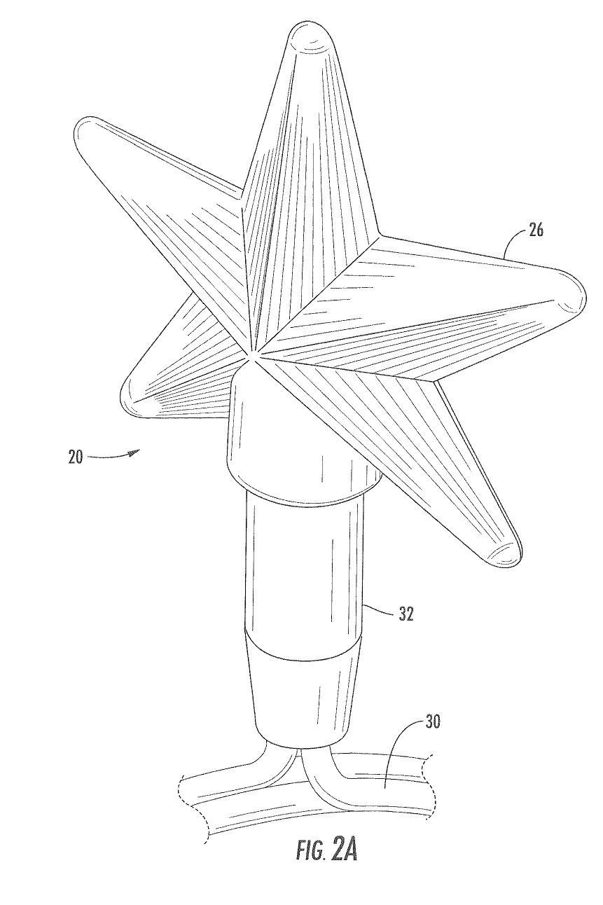

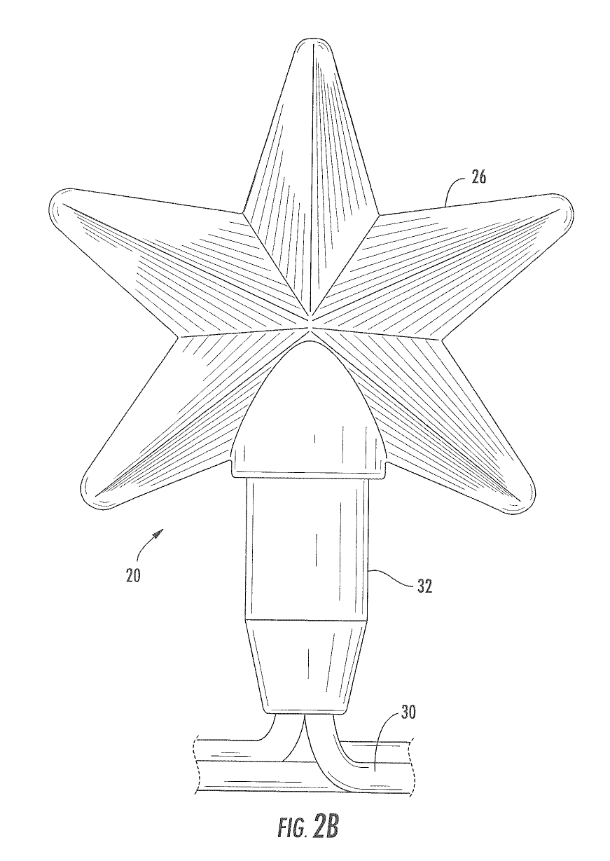

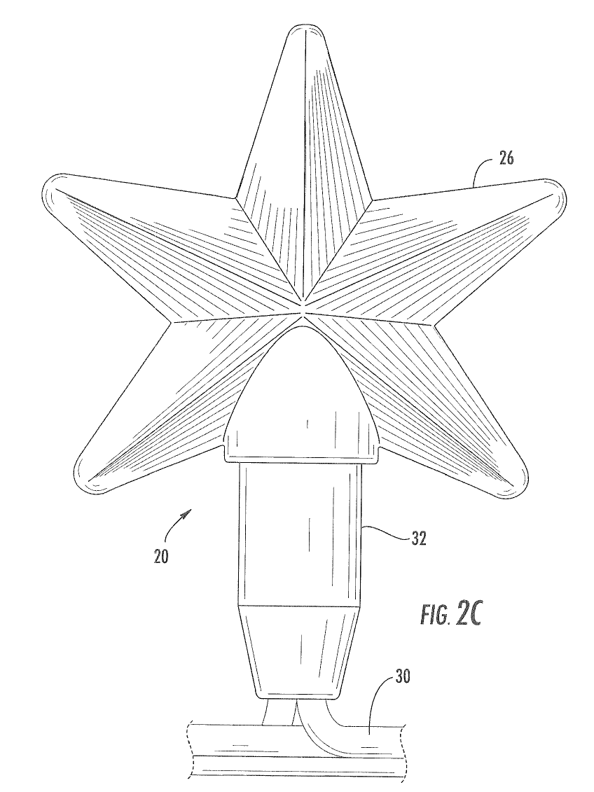

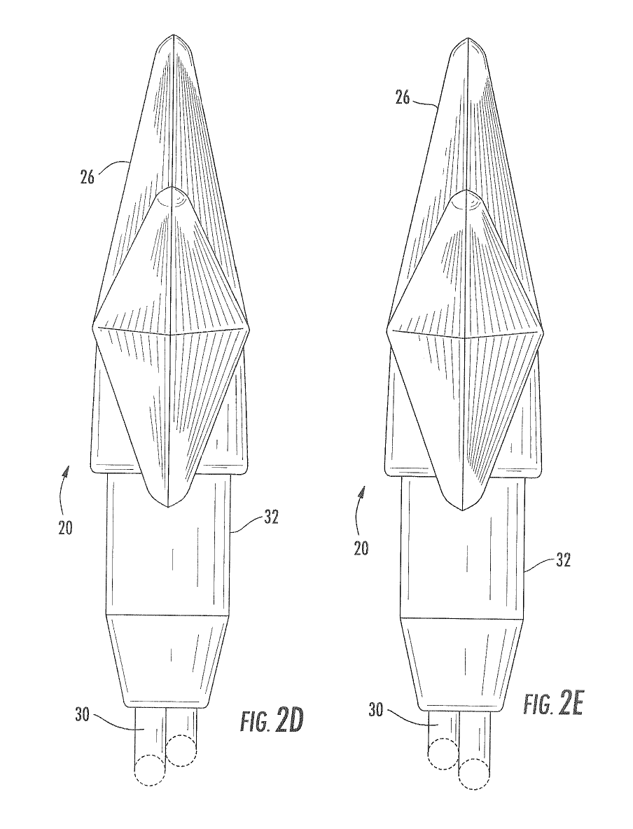

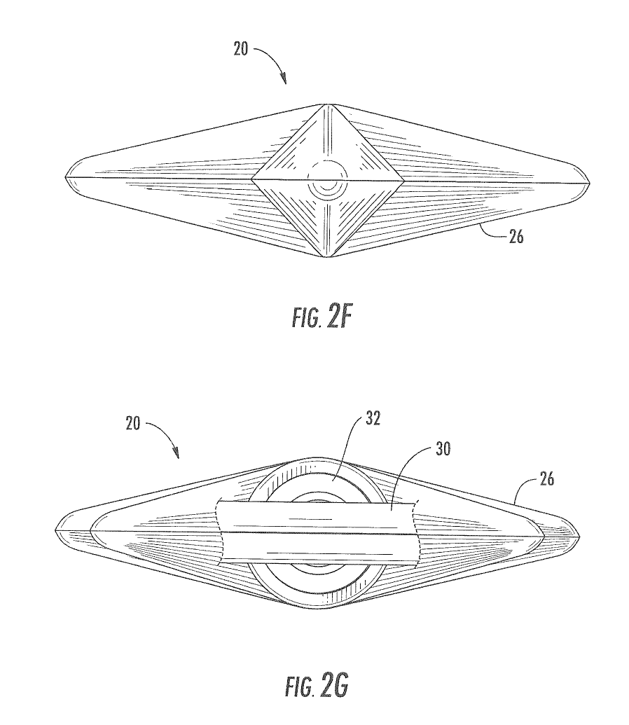

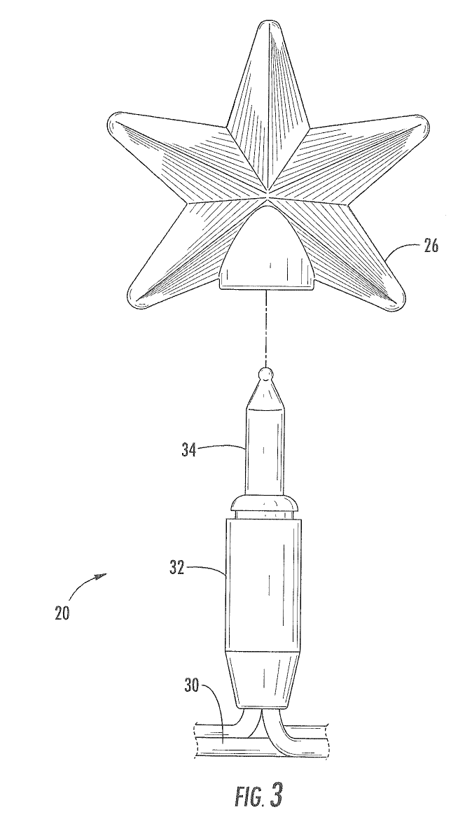

FIGS. 2-4 illustrate an individual surround 26 and a particular associated light 34 in more detail. FIGS. 2A-2G illustrates an individual surround 26 positioned upon light 34 while light 34 is illuminated. FIG. 3 illustrates the same surround 26 removed from the light 34.

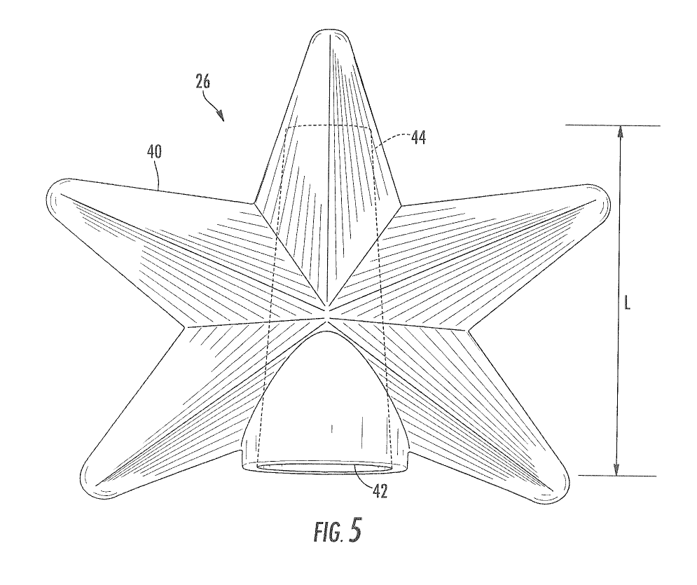

FIG. 4 illustrates the same light surround 26 positioned upon a lit light 34. When light 34 is lit, the light emitted by light 34 left in shown in FIG. 3) passes through a translucent surround 26. Because surround 26 is translucent, surround 26 functions similar to a light pipe. As a result, not only is the color of the light from light 34 changed but its shape is changed as well. Instead of the emitted light having the shape of an oval or circle (the shape of the global light between the two filaments) in the case of a clear bulb, the light has a distinct three-dimensional shape, such as the illustrated star. Instead of the emitted light having the shape of a cylinder with a pointed or conical tip in the case of a colored or tinted bulb, the light has a distinct three-dimensional shape, such as the illustrated star. Surround 26 enables a person to choose the shape of the light being illuminated from each and every light 34 along the string. The surrounds 26 enable a person to choose different shapes as well as different colors to form a desired pattern in accordance with the users particular preferences or in accordance with a particular season or time of year. For example, by replacing surrounds on the same light string, a person may provide a light string having stars, Christmas trees or other shapes for Christmas, Clark's for Valentine's Day, shamrocks for St. Patrick's Day or even numbers for a person's birthday. Such are but a few examples of the multitude of different shapes and patterns that are enabled by surrounds 26.

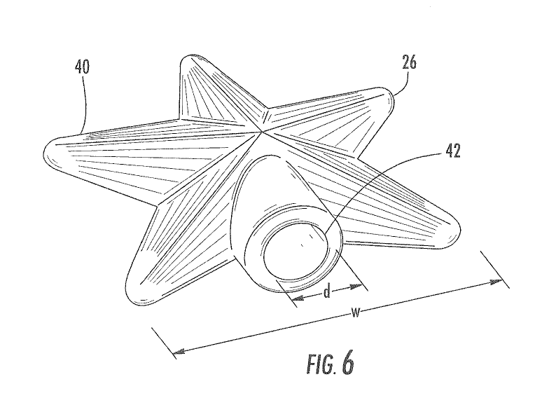

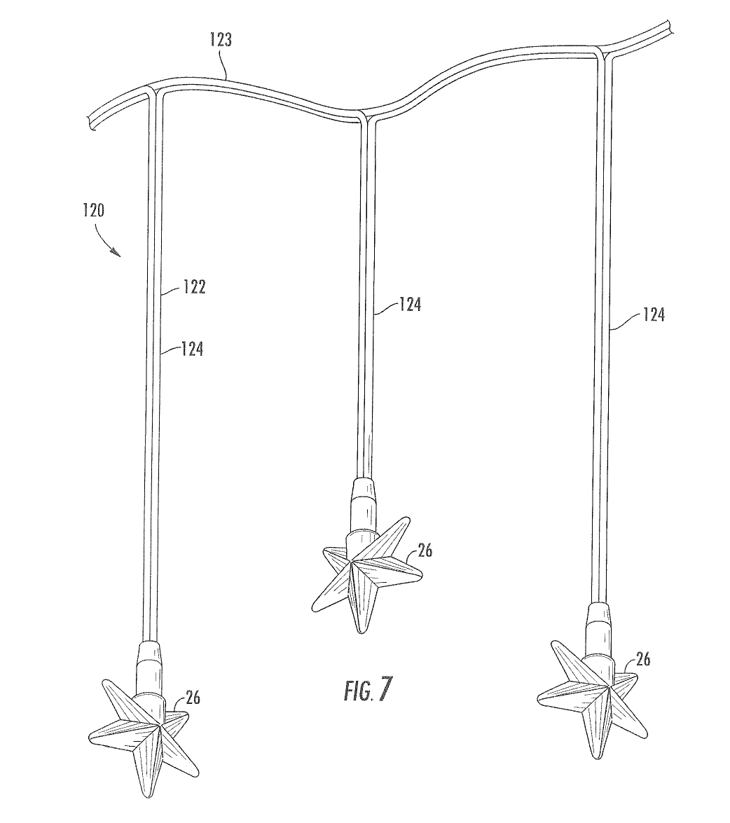

FIGS. 5 and 6 illustrate the same light surround 26 in even more detail. FIG. 6 illustrates a general size of surround 26. As shown by FIG. 5, surround 26 generally includes a translucent body 40 having an opening 42 which is in communication with an internal cavity 44 (shown in broken lines). Body 40 comprises a three-dimensional mass of translucent flexible material extending about and defining cavity 44. In the example illustrated, body 40 is formed a single homogenous mass of silicone molded into a desired three-dimensional configuration or shape about a plug or male molding die, which upon being removed, forms cavity 44 and opening 42. In the example illustrated, the silicone material is colored by pigment or die.

In one embodiment, body 40 is additionally provided with a desired scent. For purposes of this disclosure, the term “scent,” shall mean any chemical or material added to body 40 that causes body 42 discharge a scent perceptible by a human nose that is distinct from the smell otherwise associated with the silicone material itself forming body 40. In the particular example illustrated, the chemical or material added to body 40 is not visible or perceivable to a naked human eye. In one embodiment, the chemical or material added to body 40 is absorbed by, dissolved in or is otherwise translucent or transparent. In another embodiment, the material or chemical added to body 40 to provide body 40 with a scent is visible to a human eye. For example, one embodiment, portions of body 40 may be coated with a scented material. In another embodiment, visible scent emitting particles may be patterned order randomly distributed throughout and within body 40. Examples of such particles include, but are not limited to, seeds, coffee grains, and the like. In particular embodiments, such scent emitting chemicals or materials may be configured to emit an elevated level of scent in response to heat from light 34 when light 34 is illuminated.

In some embodiments, body 40 may additionally be provided with embeds 46 (schematically shown in FIG. 1). Examples of embeds include dried flowers, coffee grains, seeds, glitter, hazelnut coffee grains or crystals commercially available under the brand FOLGERS. In one embodiment, embeds comprise poppy seeds. In yet other embodiments, embeds may comprise a whole, ground or cut materials such as seeds, spices, or ground plant or flower parts. In other embodiments, and then throughout body 40 may comprise granules or flakes visible through material of body 40. In other embodiments, embeds may comprise phosphors, which upon being excited, such as upon receiving ultraviolet light or radiation from bulb of light 34, emit visible light. Embeds are generally provided by mixing such embeds in one or more materials of layers body 40 while the one or more materials of layer body 40 are in a fluid state. For example, in embodiments where body 40 is formed from silicone, such embeds in body 40 are mixed and distributed throughout the silicone or prior to the silicone being cured and while the silicone is in a fluid state. Upon curing or solidifying, the flexible material of body 40 fixes particulate material throughout the matrix of material provided by the material of body 40.

Embeds including embedded objects comprise miniature objects having shapes corresponding to full-sized objects and formed from plastic, wood, metal or other materials. In one embodiment such embedded objects may have shapes corresponding to holidays such as hearts, stars, shamrocks, crosses, eggs, pumpkins, witches and the like. And one embodiment, embeds comprising objects may be colored or may have multiple colors associated with a particular holiday or event. In one embodiment, embed objects may comprise one or more alphanumeric symbols or words.

Embeds including bubbles comprise pockets or cavities of air or other gas dispersed or distributed throughout body 40. Such embeds may visually alter light or other electromagnetic radiation being transmitted through a material of body 40 or being reflected or emanating from other embeds. In particular embodiments, embeds comprising bubbles may be uniformly distributed throughout body. In other embodiments, such bubble embeds may be non-uniformly distributed within the layers. According to one embodiment, bubble embeds are formed by injecting air or other gas into the material of body 40 prior to the material of body 40 solidifying, curing or hardening. In particular embodiments, bubble embeds may alternatively be formed by the addition of a gassing agent to the one or more materials of body 40.

According to one example embodiment, body 40 is configured as a three-dimensional structure integrally formed homogenously from a single flexible and translucent material, such as silicone. As a result, body 40 may be more easily fabricated. In other embodiments, body 40 may be integrally formed from more than one flexible and translucent material. For example, in one embodiment, body 40 may alternatively be formed from multiple silicone materials which are molded in distinct internal portions of a mold or which are layered about one another in a mold. In still other embodiments, body 40 may be formed from both flexible and inflexible materials. Portions of body 40 adjacent to cavity 44 are flexible while portions of body 40 distant cavity 44 are in flexible. In addition, portions distant from cavity 44 may be opaque.

According to one example embodiment, body 40 is provided with a three-dimensional shape associated with a holiday. In the particular example illustrated, body 40 is illustrated as a star which may be associated with Christmas or the US holiday of the Fourth of July. In other embodiments, body 40 may have other holiday-associated shapes such as pumpkins, eggs, trees, bells, flags, shamrocks, parts and the like. Body 40 may also be provided with a three-dimensional shape associated with an event. For example, body 40 may be configured as a bell associated with a wedding or a diploma associated with a graduation party. Body 40 may also be configured to be associated with a person, school, institution or company. For example, body 40 may be provided with a shape corresponding to or associated with a company trademark or logo, a college mascot or symbol and the like.

Opening 42 communicates with an interior of cavity 44 and permits insertion and withdrawal of light 34 into and from cavity 44. Cavity 44 removably receives light 34. Opening 42 and cavity 44 are configured to cooperate with one another such that during insertion of light 34 into cavity 44, light 34 is removably retained in cavity 44 without the need for additional glue, adhesive or other fastening materials. In the particular example illustrated, body 40 is configured to removably retain light 34 in cavity 44 using both friction/compression and suction. In the example illustrated, cavity 44 has a width or diameter slightly less than the width or corresponding diameter of light 34 to be received within cavity 44. Because body 40 is formed from a flexible material, during insertion of light 34 into cavity 44, body 44 stretches or flexes about light 34. As a result, surround 26 is held onto light 34 by friction with the exterior of light 34.

According to one embodiment, cavity 44 is configured such that over half and about two thirds of an outer surface of the bulb of light 34 projecting from socket 32 is contacted by body 40, providing an enhanced friction fit between body 40 and light 34. In one embodiment, body 40 frictionally contacts the exterior of the bulb of light 34 for least about 0.25 inches and nominally at least about 0.5 inches. In one embodiment, this distance by which body 40 contacts the exterior of the bulb of light 34 constitutes or one half and about two thirds of the outer surface area of the bulb of light 34 projecting from socket 32.

In the particular embodiment illustrated, opening 42 and cavity 44 are configured such that during insertion of light 34 into cavity 44, existing air within cavity 44 is expelled through opening 42 to make room for light 34. Because body 44 forms a seal against light 34 within cavity 44, withdrawal of light 34 from cavity 44 create a suction within cavity 44 tending to resist withdrawal of light 34 from cavity 44. According to one embodiment, cavity 44 is configured such that over half and about two thirds of an outer surface of the bulb of light 34 projecting from socket 32 is contacted by body 40, providing an enhanced seal between body 40 and light 34. In one embodiment, body 40 virtually contacts the exterior of the bulb of light 34 for least about 0.25 inches and nominally at least about 0.5 inches. In one embodiment, this distance by which body 40 contacts the exterior of the bulb of light 34 constitutes or one half and about two thirds of the outer surface area of the bulb of light 34 projecting from socket 32. In those embodiments in which body 40 is formed from silicone, the ability of body 40 to be retained a light 34 with such friction and suction is enhanced. In other embodiments, cavity 44 and opening 42 may alternatively be configured as a body 40 is retained upon light 34 by either friction or suction or by other removable retention methods.

In the particular example embodiment illustrated, surround 26 is configured for being removably positioned upon a mini-light. Mini-lights are typically provided in strings. Such mini lights may fail to work as a result of the light 34 burning out or as a result of damage to the electrical connection between light 34 and socket 32. Due to the relatively small size of mini-lights and their non-screw socket connection, such issues are more frequent as compared to other incandescent light bulbs. As a result, strings of mini-light or more commonly discarded and replaced, especially given their relatively low retail cost.

Surrounds 26 specifically configured for being removably mounted on mini-lights are especially advantageous. In particular, surround 26 may be easily removed from the mini-lights prior to the entire string being discarded. As a result, waste is reduced. In addition, due in part to their relatively small size, strings of mini-lights prickly include a larger number of individual lights. Because surrounds 26 are removable, surrounds 26 may be selectively positioned upon some, but not all of the lights 34 to avoid weighing down of the string or a structure object supporting the string of lights. Moreover, because surrounds 26 are removable, a string of lights may be customized according to a user's preferences or tastes or may be customized depending on the particular holiday or event. For example, person may place a first set of surrounds 26 on string 22 for a first holiday or event. The person may be a first set of surrounds 26 with a second set of surrounds 26 for a second holiday or event. The person may also intermix or intermingle surrounds 26 on a single light string. Different surrounds 26 may be arranged in any of a number of patterns along the string 26 according to a user's preferences or tastes. In those embodiments in which surrounds 26 are scented, a mix of different scents may be provided along a string of lights by using or intermixing different scented surrounds 26.

As shown by FIGS. 5 and 6, surround 26 is configured for use with mini-lights. As shown by FIG. 6, cavity 44 is generally conical shaped, corresponding to be cylindrical or conical shape of a mini light. In the example illustrated in FIG. 5, cavity 44 as an axial length L of at least about ⅝ of an inch. Cavity 44 has a substantially uniform or uniformly varying cross-sectional diameter such that a majority of the outer surface of a mini light is contacted by body 40 when inserted into cavity 44. Cavity 44 is further provided with an axial length such that an axial midpoint of cavity 44 is substantially centered at a center point of body 40. In the particular embodiment illustrated, cavity 44 has an axial length such that cavity 44 has an axial midpoint substantially located at a center point of the star configuration. Cavity 44 is configured such that the brightest part of light 34, when illuminated, will extend into close proximity with a center point of body 40. In particular, cavity 44 configured such that the filaments of the incandescent bulb of light 34 are located at or just below a center point of the star shape of body 40. As a result, greater portion of body 40 is illuminated by light 34.

FIGS. 5 and 6 also illustrate dimensions of the example surround 26. As shown by FIG. 6, opening 42 has a diameter d of about 3/16 of an inch. As a result, light 34, comprising a mini-light, they be easily inserted into cavity 44. Body 40 of surround 26 has a width W of about 1 and 2/16 of an inch. In other embodiments, body 40, opening 42 and cavity 44 may have other shapes and dimensions.

FIG. 7 illustrates picture lighting system 120, another embodiment of Dr. lighting system 20. Decorative lighting system 120 is similar to decorative lighting system 20 except that decorative lighting system 120 includes a light string 122 in place a light string 22. As shown by FIG. 7, light string 122 includes a main line 123 and a plurality of hanging branches 124 which support individual mini lights having surrounds 26 position thereon. As with decorative lighting system 20, surrounds 26 enable decorative lighting system 122 be customized by allowing a person to selectively choose not only the color but the particular shape of the illumination of each mini light. This pattern or arrangement may be changed as often as the person desires depending upon the person's preferences, the particular holiday season or other uses of lighting system 120.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A decorative lighting apparatus comprising:
a plurality of mini-light surrounds, each surround formed from silicone, including a conical cavity configured to stretch when receiving a mini-light to removably retain the surround on the mini-light and having an outer three dimensional shape different than the mini-light.

2. The apparatus of claim 1, wherein substantially an entirety of the surround is translucent and is configured to be illuminated by the mini-light such that the surround forms an illuminated shape different that the mini-light when the mini-light is lit.

3. The apparatus of claim 1, wherein the cavity is configured such that insertion of the mini-light into the cavity expels air from the cavity such that removal of the mini light from the cavity creates suction that assists in retaining the surround on the mini-light.

4. The apparatus of claim 1, wherein the cavity is substantially conical shaped.

5. The apparatus of claim 1, wherein the cavity has an axial midpoint substantially at a center of the surround.

6. The apparatus of claim 1, when the surround is colored.

7. The apparatus of claim 1, wherein the surround is scented.

8. The apparatus of claim 1, wherein the plurality of surrounds have different colors.

9. The apparatus of claim 1, wherein the silicone is translucent.

10. The apparatus of claim 1, wherein the cavity has an opening of about 3/16 of an inch.

11. The apparatus of claim 1, wherein the cavity has an axial length of at least about ⅝ of an inch.

12. The apparatus of claim 1, wherein the cavity has an opening of about 3/16 of an inch and an axial length of about ⅝ of an inch.

13. The apparatus of claim 1, wherein the cavity has a substantially uniform internal diameter extending at least about 7/16 of an inch from an opening of the cavity.

14. The apparatus of claim 1, wherein the surround has a three-dimensional outer shape distinct from the outer shape of a light bulb to be removably received by the surround.

15. The apparatus of claim 1, wherein the plurality of surrounds are configured in shapes associated with holidays.

16. The apparatus of claim 17, wherein the plurality of surrounds have one or more shapes selected from a group of shapes consisting of: stars, pumpkins, eggs, trees, bells, flags, shamrocks, hearts, candy canes, packages, bunnies, crosses, and diplomas.

17. The apparatus of claim 1, wherein the cavity has an axial midpoint substantially at a center of the surround and wherein the cavity has an axial length of about ⅝ of an inch.

18. The apparatus of claim 1 further comprising a string of mini lights, at least some of the mini-lights removably received in cavities of the plurality of mini-light surrounds.

19. The apparatus of claim 1, wherein the cavity has an inner diameter less than or equal to an outer diameter of the mini-light to be received by the surround prior to receiving the mini-light.

20. The apparatus of claim 1, wherein the cavity has an inner diameter less than an outer diameter of the mini-light to be received by the surround prior to receiving the mini-light.

21. A decorative lighting apparatus comprising:
a plurality of light bulb surrounds, each surround formed from silicone, including a flexible cavity configured to stretch against a light bulb to removably retain the surround on the light bulb and having an outer three dimensional shape different than the cavity.

22. The apparatus of claim 21, wherein substantially an entirety of the surround is translucent and is configured to be illuminated by the mini-light such that the surround forms an illuminated shape different that the mini-light when the mini-light is lit.

23. The apparatus of claim 21, wherein the cavity has an inner diameter less than or equal to an outer diameter of the light bulb to be received by the surround prior to receiving the light bulb

24. The apparatus of claim 21, wherein the plurality of surrounds have different colors.

25. The apparatus of claim 21, wherein the cavity is configured such that insertion of the light bulb into the cavity expels air from the cavity such that removal of the light bulb from the cavity creates suction that assists in retaining the surround on the light bulb.

26. The apparatus of claim 21, wherein the silicone is translucent.

27. The apparatus of claim 21, wherein the cavity has an axial length of less than or equal to about 1 inch.

28. The apparatus of claim 27, wherein the cavity as an axial midpoint substantially at a center of the surround.

29. The apparatus of claim 21, wherein the silicone includes a scent.

30. A method comprising:
inserting a mini-light of a string of mini-lights into a silicone surround having an outer shape distinct from that of the mini-light, wherein the surround is frictionally retained on the mini-light; and
illuminating the mini-light such that light from the mini-light illuminates the surround and takes the shape of the surround.
